(19) United States
(12) Patent Application Publication
(10) Pub. No.: US 2007/0286939 A1
(43) Pub. Date: Dec. 13, 2007

(54) Shea butter alkoxylated phosphate esters

(76) Inventors: Steven Rogers, Yardley, PA (US); Anthony O'Lenick, Dacula, GA (US)

Correspondence Address: Louis C. Paul & Associates, PLLC, 9th floor, 730 Fifth Avenue, New York, NY, 10019, US

(21) Appl. No.: 11/449,642

(22) Filed: Jun. 9, 2006

(51) Int. Cl. A23D 9/00

(52) U.S. Cl. 426/607

(57) ABSTRACT

Novel shea butter polyoxyalkylene glycol phosphate esters prepared by the reaction of a polyoxyethylene glycol (PEG) or polyoxypropylene glycol (PPG) or mixtures thereof with shea butter, preferably mild-processed shea butter (MPSB), followed by phosphation under specific mild-processing conditions. These materials are useful as cosmetic and personal care ingredients, allowing for the delivery of highly desirable active ingredients present in shea butter, including natural antioxidants, in a water-soluble form that is substantive to the skin and hair.

### CROSS-REFERENCE TO RELATED APPLICATIONS

Not applicable.

### Statement Regarding Federally-Sponsored Research or Development

Not applicable.

### FIELD OF THE INVENTION

The present invention relates to novel shea butter alkoxylated phosphate esters prepared by the reaction of shea butter, preferably mild-processed shea butter (MPSB), with polyoxyalkylene glycols, including polyoxyethylene glycol, polyoxypropylene glycol and mixtures thereof, followed by phosphation with a suitable phosphation reagent selected from the group consisting of polyphosphoric acid and P₂O₅. These compounds are useful as cosmetic and personal care ingredients, allowing for the delivery of highly desirable active ingredients present in the shea butter including natural antioxidants, in a water-soluble form that is substantive to the skin and hair.

### BACKGROUND OF THE INVENTION

Shea Butter is a butter extracted from the kernel of Butrospermum parkii. This plant, also referred to as Vitellaria paradoxa, is native to Africa. The term butter describes a material that is a solid at room temperature, but melts at about 40° C. Chemically, the butter is a triglyceride conforming to the following structure

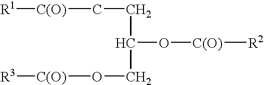

wherein R¹, R² and R³ each have one of the following compositions:

| R Group | Common Name | Range (%) | Typical (%) |
|---|---|---|---|
| C₁₁H₂₃ | Lauryl | 0.1–2.0 | 0.2 |
| C₁₃H₂₇ | Myristyl | 0.5–2.0 | 1.0 |
| C₁₅H₃₁ | Cetyl | 2.0–6.0 | 4.0 |
| C₁₇H₃₅ | Stearyl | 25.0–50.0 | 35.0 |
| C₁₇H₃₃ | Oleyl | 40.0–60.0 | 59.0 |
| C₁₇H₃₁ | Linoleyl | 0.5–1.0 | 0.8 |

100061 The average composition of R² is different than R¹ and R³, the latter two being similar. The R² moiety contains predominantly the unsaturated C₁₈ group (oleyl) while R¹ and R³ contain predominantly the saturated C₁₈ group (stearyl). Differences between internal (R²) and terminal (R¹, R³) substitution are seen in natural products but not in synthetic molecules produced in the laboratory.

The high levels of stearyl and oleyl groups in shea butter, particularly in mild-processed shea butter, and their alkoxylated phosphate derivatives make them of particular interest in the personal care industry. While other raw materials used in personal care products have these species, the compounds of the present invention have significantly high concentrations of unsaponifiables, which posses highly desired antioxidant, ultra-violet radiation protection, and free-radical scavenging properties. Shea butter alkoxylated phosphate esters, and particularly MPSB alkoxylated phosphated esters, of the present invention typically contain from about 5% to about 15% by weight of unsaponifiables. In contrast, other butters commonly used in personal care products have less than 2% unsaponifiables. For example, coca butter (from Theobroma cacao) averages 0.4% unsaponifiables and Illipe butter (from Shorea stenoptera) averages 1.1%.

As described in greater detail below, the novel shea butter and MPSB alkoxylated phosphate esters of the present invention are produced by the transesterification of shea butter or MPSB with one or a combination of polyoxyalkylene glycols followed by phosphation. By “mild processed” is meant processes that do not remove or otherwise diminish the amount or potency of active ingredients, particularly highly desired unsaponifiables. In the present invention, mild processing is employed both at the time of harvesting and initial extraction (creating mild-processed shea butter) and during subsequent preparation of its alkoxylated phosphate derivatives. These processes result in materials containing unexpectedly high amounts unsaponifiables, notably antioxidants.

The novel alkoxylated phosphate esters of the present invention are thus water-soluble emollients and emulsifiers that not only not only condition and soften skin and hair, but also deliver antioxidants (present in the unsaponifable fraction of mild-processed shea butter) in a heretofore unachievable manner.

### SUMMARY OF THE INVENTION

The compounds of the present invention are shea butter alkoxylated phosphate esters produced by a transesterification reaction of shea butter with polyoxyalkylene glycol compounds followed by phosphation of the resulting alkoxylate. Preferably, the shea butter is mild-processed, and the reactions are conducted under specific mild-processing conditions. The novel alkoxylated phosphate esters of the present invention are rich in unsaponifiables, including antioxidants.

### DETAILED DESCRIPTION OF THE INVENTION

The present invention relates to a novel class of alkoxylated phosphate esters made by reacting shea butter with polyoxyethylene glycol or polyoxypropylene glycol or mixtures thereof followed by phosphation of the resulting phosphate ester. The invention is also directed to a process for using the shea butter alkoxylated phosphate esters in personal care applications. Preferably, mild processing is employed both at the time of harvesting and initial extraction and during subsequent preparation of alkoxylate derivatives. In so doing, materials containing unexpectedly high amounts of active ingredients, particularly highly desired unsaponifiables, are produced.

Shea butter (and MPSB) alkoxylated phosphate esters of the present invention conform to the following structure:

Rₓ—C(O)—O—(CH₂CH₂O)ₐ—(CH₂CH(CH₃)O)_{b}—(CH₂CH₂O)_{c}—P(O)—(O⁻M⁺)₃

wherein

Rₓ, is shea butter or, preferably mild-processed shea butter, which comprises
from about 0.1% to about 2.0% by weight C₁₁H₂₃;
from about 0.5% to about 2.0% by weight C₁₃H₂₇;
from about 2.0% to about 6.0% by weight C₁₅H₃₁;
from about 25% to about 50% by weight C₁₇H₃₅;
from about 40% to about 60.0% by weight C₁₇H₃₃; and

a, b and c are independently integers ranging from 1 to 20;

M is selected from the group consisting of H, Na and K.

Another aspect of the present invention is a process for delivering antioxidants to the skin and hair by applying thereto a finished topical product comprising an effective amount of an alkoxylated phosphate ester made by an esterification reaction of shea butter, or preferably MPSB, and polyoxyalkylene glycol thereof that conforms to the following structure:

Rₓ—C(O)—O—(CH₂CH₂O)ₐ—(CH₂CH(CH₃)O)_{b}—(CH₂CH₂O)_{c}—P(O)—(O⁻M⁺)₃

wherein

Rₓ is derived from shea butter, preferably mild-processed shea butter, which comprises
from about 0.1% to about 2.0% by weight C₁₁H₂₃;
from about 0.5% to about 2.0% by weight C₁₃H₂₇;
from about 2.0% to about 6.0% by weight C₁₅H₃₁;
from about 25% to about 50% by weight C₁₇H₃₅;
from about 40% to about 60.0% by weight C₁₇H₃₃;

a, b and c are independently integers ranging from 1 to 20; and

M is selected from the group consisting of H, Na and K.

By “finished topical product” is meant a cream, lotion, gel, foam, ointment, paste, emulsion, suspension, dispersion, solution, or similar topically-applied carrier or delivery system known to those of skill in the art.

Shea butter can be prepared by standard extraction techniques known to those of skill in the art. For example, U.S. Pat. No. 6,552,208, the disclosure of which is incorporated herein by reference, describes several methods for processing shea butter. Suitable extraction vehicles may include, but are not limited to, ethanol, methanol, ethyl acetate, acetone, chloroform and water, or any other solvent and water.

Sterols comprise about 20% of the unsaponifiables in shea butter. More particularly, the sterols comprise: cholesterol (from about 1% to about 3%); alpha-spinasterol (from about 1% to about 4%); delta-7-stigmasterol (from about 40% to about 44%); delta-7-avenasterol (from about 38% to about 41%). The remaining constituents of the unsaponifiables (about 80%) include other highly desirable active compounds including tocopherol, karitin, cinamic acid esters, alpha and beta amyrin and phenolics.

Phenolic compounds are natural products composed of one or more aromatic benzene rings with one or more hydroxyl group. They are a class of natural products that possess antioxidant and free radical scavenging properties. Among the phenolics in the unsaponifiables of mild-processed shea butter include gallic acid, gallocatchin, catechin, epigallocatechin gallate, epicatechin, gallocatechin gallate, gallocatechin gallate and quercetin.

In a preferred aspect of the present invention, shea butter is mild-processed; it is extracted using a hydrocarbon-free solvent system and its polyoxyalkylene ester derivatives of the present invention are made under mild processing conditions. At the time of harvesting and initial extraction ground-up kernels are boiled in water under mild conditions as described in the example below. The oil phase is then separated from the water phase by decanting. This process provides a yellow, solid wax rich in unsaponifiables. By wax is meant a material obtained by boiling in water under ambient conditions, decanted and filtered.

MPSB is made according to following procedure: 500.0 grams of the nut form the Shea Butter tree are cracked into small pieces and placed into a one-liter vat of water. The water is then heated to 100° C. As the temperature increases, an oil phase develops on the surface of the water. The temperature is held for about 2 hours, after which the oil is decanted and passed through filter paper. The resulting butter is mild-processed shea butter according to the present invention. It is rich in unsaponifiable (from about 7% to about 15% by weight) and may be used in making the MPSB polyoxyalkylene glycol esters of the present invention.

Mild processing according to this aspect of the present invention may be contrasted with separation using solvents and high temperature treatment with high pressure steam. While the latter processes result in what some may describe as a “more pure” triglyceride, unsaponifiables, and the benefits derived therefrom, are lost. Vacuum distillation which strips off the desirable components is also to be avoided in processing MPSB of the present invention. By processing shea butter under mild conditions, materials comprising from about 5% to about 15% by weight of unsaponifiables can be produced.

Polyoxyalkylene Glycols

Polyoxyalkylene glycols are items of commerce and conform to the following structure:

H—(OCH₂CH₂)ₐ—(CH₂CH(CH₃)O)_{b}—(CH₂CH₂O)_{c}—H

wherein, a, b and c are independently integers ranging from 1 to 20. Illustrative, but not limiting, examples of polyoxyalkylene glycols which may in preparing the esters of the present invention are set out below:

| Example | A | b | C |
|---|---|---|---|
| 1 | 1 | 0 | 0 |
| 2 | 10 | 0 | 0 |
| 3 | 0 | 10 | 0 |
| 4 | 5 | 1 | 5 |
| 5 | 5 | 10 | 10 |
| 6 | 20 | 20 | 20 |

It will be clearly understood that by polyoxyalkylene glycol compounds is meant three different classes of compounds. Polyoxyethylene glycols are compounds in which “b” is zero; polyoxypropylene glycols are compounds in which “a” and “c” are zero and polyoxyalkylene glycols compounds in which “a” and/or “c” are not zero and “b” is not zero.

The following examples are illustrative of the alkoxylation step in creating the compounds of the present invention. The components and specific ingredients are presented as being typical, and various modifications can be derived in view of the foregoing disclosure within the scope of the invention. All percentages, ratios and proportions herein are by weight, unless otherwise specified. All temperatures are in degrees Celsius unless otherwise specified.

Polyoxyalkylene glycols as described in Examples 1-6 are reacted with shea butter, and more preferably MPSB, as follows: To 145.0 grams of shea butter (or MPSB) are added the number of grams of polyoxyalkylene glycols in Examples 7-18. Using a reflux condenser, the temperature of the mass is raised to 180° C.-190° C. The mass is held within this temperature range for 10 hours. Nothing is distilled off during this time, and the reaction mass becomes hazy. The reaction mass is cooled, glycerin separates off and is removed from the bottom. The products of Example 7-18 may be used in formulating finished cosmetic and personal care products without additional purification.

| | Polyoxyalkylene | Glycol |
|---|---|---|
| Example | Example | Grams |
| 7 | 1 | 22.0 |
| 8 | 2 | 220.0 |
| 9 | 3 | 295.0 |
| 10 | 4 | 249.5 |
| 11 | 5 | 595.0 |
| 12 | 6 | 1470.0 |
| 13 | 1 | 33.0 |
| 14 | 2 | 330.0 |
| 15 | 3 | 442.5 |
| 16 | 4 | 3742.5 |
| 17 | 5 | 897.5 |
| 18 | 6 | 2205.0 |

Phosphation Reagents

Polyphosphoric acid (CAS No. 008017-16-1) and P₂O₅ (CAS No. 1314-56-3) are articles of commerce well-known to persons of skill in the art. These reagents are reacted with the above-described alkoxylated shea butter (and MPSB) to produce the compounds of the present invention.

The following examples are further illustrative of the phosphation step in creating the compounds of the present invention. 49 grams of polyphosphoric acid are added to the specified grams of the polyoxyalkylene glycol shea butter ester of Examples 7-18. The reaction mass is stirred well until homogeneous then heated to, 90° C. for about 4 to 5 hours.

| Example | Example | Grams |
|---|---|---|
| 19 | 7 | 167.0 |
| 20 | 8 | 365.0 |
| 21 | 9 | 440.0 |
| 22 | 10 | 395.0 |
| 23 | 11 | 740.0 |
| 24 | 12 | 2355.0 |
| 25 | 13 | 178.0 |
| 26 | 14 | 653.0 |
| 27 | 15 | 587.5 |
| 28 | 16 | 3887.0 |
| 29 | 17 | 1042.0 |
| 30 | 18 | 2350.0 |

Alternatively, as illustrated below, 24 grams P₂O₅ are added under good agitation to the specified grams of polyoxyalkylene glycol shea butter ester of Examples 7-18. The reaction mass is stirred well until homogeneous then heated to, 90° C. for about 4 to 5 hours.

| Example | Example | Grams |
|---|---|---|
| 31 | 7 | 334.0 |
| 32 | 8 | 730.0 |
| 33 | 9 | 880.0 |
| 34 | 10 | 790.0 |
| 35 | 11 | 1480.0 |
| 36 | 12 | 4710.0 |
| 37 | 13 | 356.0 |
| 38 | 14 | 1396.0 |
| 39 | 15 | 1174.0 |
| 40 | 16 | 7774.0 |
| 41 | 17 | 2084.0 |
| 42 | 18 | 4700.0 |

The compounds of the present invention are effective surface active agents that provide emmoliency as well as mild detergency. They are well tolerated by the skin and eye and deliver antioxidants to the skin.

While the illustrative embodiments of the invention have been described with particularity, it will be understood that various other modifications will be apparent to and can be readily made by those skilled in the art without departing from the spirit and scope of the invention. Accordingly, it is not intended that the scope of the claims appended hereto be limited to the examples and descriptions set forth hereinabove but rather that the claims be construed as encompassing all the features of patentable novelty which reside in the present invention, including all features which would be treated as equivalents thereof by those skilled in the art to which the invention pertains.

1. A shea butter alkoxylated phosphate conforming to the structure:
Rₓ—C(O)—O—(CH₂CH₂O)ₐ—(CH₂CH(CH₃)O)_{b}—(CH₂CH₂O)_{c}—P(O)—(O⁻M⁺)₃
wherein
Rₓ, is shea butter or, preferably mild-processed shea butter, which comprises
from about 0.1% to about 2.0% by weight C₁₁H₂₃;
from about 0.5% to about 2.0% by weight C₁₃H₂₇;
from about 2.0% to about 6.0% by weight C₁₅H₃₁;
from about 25% to about 50% by weight C₁₇H₃₅;
from about 40% to about 60.0% by weight C₁₇H₃₃; and
a, b and c are independently integers ranging from 1 to 20;
M is selected from the group consisting of H, Na and K.

2. A shea butter alkoxylated phosphate ester of claim 1 wherein
a is 1, b is 0 and c is 0.

3. A shea butter alkoxylated phosphate ester of claim 1 wherein
a is 10, b is 0 and c is 0.

4. A shea butter alkoxylated phosphate ester of claim 1 wherein
a is 0, b is 10 and c is 0.

5. A shea butter alkoxylated phosphate ester of claim 1 wherein
a is 5, b is 1 and c is 5.

6. A shea butter alkoxylated phosphate ester of claim 1 wherein
a is 5, b is 10 and c is 10.

7. A shea butter alkoxylated phosphate ester of claim 1 wherein
a is 20, b is 20 and c is 20.

8. A process for delivering antioxidants to the hair and skin by applying thereto a finished topical product comprising an effective concentration of a mild-processed shea butter alkoxylate conforming to the structure:
Rₓ—C(O)—O—(CH₂CH₂O)ₐ—(CH₂CH(CH₃)O)_{b}—(CH₂CH₂O)_{c}—P(O)—(O⁻M⁺)₃
wherein
Rₓ, is shea butter or, preferably mild-processed shea butter, which comprises
from about 0.1% to about 2.0% by weight C₁₁H₂₃;
from about 0.5% to about 2.0% by weight C₁₃H₂₇;
from about 2.0% to about 6.0% by weight C₁₅H₃₁;
from about 25% to about 50% by weight C₁₇H₃₅;
from about 40% to about 60.0% by weight C₁₇H₃₃; and
a, b and c are independently integers ranging from 1 to 20;
M is selected from the group consisting of H, Na and K.

9. A process of claim 8 wherein a is 1, b is 0 and c is 0.

10. A process of claim 8 wherein a is 10, b is 0 and c is 0.

11. A process of claim 8 wherein a is 0, b is 10 and c is 0.

12. A process of claim 8 wherein a is 5, b is 1 and c is 5.

13. A process of claim 8 wherein a is 5, b is 10 and c is 1

14. A mild-processed shea butter alkoxylate conforming to the structure:
Rₓ—C(O)—O—(CH₂CH₂O)ₐ—(CH₂CH(CH₃)O)_{b}—(CH₂CH₂O)_{c}—P(O)—(O⁻M⁺)₃
wherein
Rₓ, is shea butter or, preferably mild-processed shea butter, which comprises
from about 0.1% to about 2.0% by weight C₁₁H₂₃;
from about 0.5% to about 2.0% by weight C₁₃H₂₇;
from about 2.0% to about 6.0% by weight C₁₅H₃₁;
from about 25% to about 50% by weight C₁₇H₃₅;
from about 40% to about 60.0% by weight C₁₇H₃₃; and
a, b and c are independently integers ranging from 1 to 20;
M is selected from the group consisting of H, Na and K.

15. A shea butter alkoxylated phosphate ester of claim 14 wherein
a is 1, b is 0 and c is 0.

16. A shea butter alkoxylated phosphate ester of claim 14 wherein
a is 10, b is 0 and c is 0.

17. A shea butter alkoxylated phosphate ester of claim 14 wherein
a is 0, b is 10 and c is 0.

18. A shea butter alkoxylated phosphate ester of claim 14 wherein
a is 5, b is 1 and c is 5.

19. A shea butter alkoxylated phosphate ester of claim 14 wherein
a is 5, b is 10 and c is 10.

20. A shea butter alkoxylated phosphate ester of claim 14 wherein
a is 20, b is 20 and c is 20.
